(19) United States
(12) Patent Application Publication
(10) Pub. No.: US 2026/0261495 A1
(43) Pub. Date: Sep. 3, 2026

(54) METHODS, SYSTEMS, AND COMPUTER READABLE MEDIA FOR USING MARKER PACKETS TO ENHANCE VIEWING AND INTERPRETATION OF CAPTURED PACKETS IN CONFORMANCE TEST RESULTS

(71) Applicant: Keysight Technologies, Inc., Santa Rosa, CA (US)

(72) Inventors: Mriganka Mouli Ghosh, Hooghly (IN); Amab Bakshi, Kolkata (IN); Sujit Kumar Kundu, Kolkata (IN)

(21) Appl. No.: 19/066,599

(22) Filed: Feb. 28, 2025

(51) Int. Cl. H04L 43/045; H04L 43/02

(52) U.S. Cl. CPC H04L 43/045; H04L 43/02; H04L 43/50

(57) ABSTRACT

A method for viewing and correlating test steps and captured packets in a network conformance test includes transmitting, to a DUT, test packets as part of a network conformance test. The method further includes generating and transmitting marker packets that identify specific test steps in the network conformance test and the marker packets are configured so as not to change a state of the DUT with respect to the network conformance test. The method further includes receiving packets transmitted by the DUT responsive to the test packets. The method further includes capturing the test packets, the marker packets, and the packets transmitted by the DUT. The method further includes displaying the marker packets, the test packets, and the packets transmitted by the DUT and allowing a user to associate test packets and the packets transmitted by the DUT with the test steps identified by the marker packets.

### TECHNICAL FIELD

The subject matter described herein relates to conformance testing of network devices. More particularly, the subject matter described herein relates to using marker packets to enhance viewing and interpretation of captured packets in conformance test results.

### BACKGROUND

Conformance testing of network devices involves transmitting packets to a device under test (DUT), receiving packets from the DUT, and viewing the packets to determine whether the DUT conforms with an expected response, such as a response specified in an industry standards document. One particular type of conformance testing that may be performed is time sensitive networking (TSN) testing. TSN is defined in a series of IEEE standards and involves synchronizing clocks of remote devices with each other so that precise timing can be achieved for industrial automation, automotive, telecommunications, and other applications.

Testing a TSN-compatible device involves sending timing synchronization packets to the DUT, receiving responsive packets from the DUT, and determining whether the DUT accurately synchronized to the clock of the test system. To determine whether the DUT conformed to the standard, timing synchronization packets are captured and viewed by the test operator. Packet capture tools, such as Wireshark, may be used to capture and view the packets.

One problem with this scenario is that verifying the conformance of the DUT to the TSN standard requires correlation of packets used to implement test steps with the corresponding test steps using the user interface of the packet capture tool to view the packets. Such user interfaces allow packet content to be viewed in a standard format, such as hexadecimal format. However, correlating packets with test steps can require the user to search through many pages or screens of data to locate corresponding packets. Such a process is time-and labor-intensive.

Accordingly, in light of these and other difficulties, there exists a need for improved methods, systems, and computer readable media for viewing interpreting network conformance test results.

### SUMMARY

A method for viewing and correlating test steps and captured packets in a network conformance test includes generating and transmitting, by a network test device and to a DUT, a plurality of test packets as part of a network conformance test. The method further includes generating, by the network test device, a plurality of marker packets that identify specific test steps in the network conformance test, wherein the marker packets are configured so as not to change a state of the DUT with respect to the network conformance test. The method further includes transmitting, by the network test device, the marker packets. The method further includes receiving, by the network test device, packets transmitted by the DUT responsive to the test packets. The method further includes capturing, by the network test device, the test packets, the marker packets, and the packets transmitted by the DUT. The method further includes displaying the marker packets, the test packets, and the packets transmitted by the DUT and thereby allowing a user to associate test packets and the packets transmitted by the DUT with the test steps identified by the marker packets.

According to another aspect of the subject matter described herein, generating the marker packets includes generating fake packets configured to cause the DUT to ignore or discard the at fake packets and wherein transmitting the marker packets includes transmitting the marker packets to the DUT.

According to another aspect of the subject matter described herein, generating the fake packets includes generating packets addressed to a destination medium access control (MAC) address different from a MAC address of the DUT.

According to another aspect of the subject matter described herein, generating the fake packets includes generating fake internet control management protocol (ICMP) packets.

According to another aspect of the subject matter described herein, the method for viewing and correlating test results in a network conformance test includes correlating the specific test steps to the test packets captured by network test device using the specific test steps identified by the marker packets.

According to another aspect of the subject matter described herein, generating the marker packets includes inserting, in the marker packets, indicators that identify whether the specific test steps were successfully completed.

According to another aspect of the subject matter described herein, transmitting the marker packets includes transmitting, after completion of a first test step and prior to beginning a second test step, a first marker packet indicating completion of the first test step.

According to another aspect of the subject matter described herein, generating the marker packets includes inserting, in the marker packets, an identifier that identifies the network conformance test.

According to another aspect of the subject matter described herein, the method for viewing and correlating captured packets in a conformance test with test steps includes feeding the test packets, the marker packets, and the packets received from the DUT to a generative artificial intelligence/machine learning (AI/ML) model trained to interpret and facilitate navigation of results of the network conformance test.

According to another aspect of the subject matter described herein, the network conformance test comprises a time sensitive networking (TSN) conformance test.

A system for viewing and correlating captured packets and test steps in a network conformance test includes a network test device including at least one processor and a memory. The system further includes a test and marker packet generator implemented by the at least one processor for generating and transmitting, to a DUT, a plurality of test packets as part of a network conformance test, generating and transmitting a plurality of marker packets, wherein the marker packets identify specific test steps in the network conformance test and the marker packets are configured so as not to change a state of the DUT with respect to the network conformance test;

a packet capture application implemented by the at least one processor for receiving packets transmitted by the DUT responsive to the test packets, capturing, by the network test device, the test packets, the marker packets, and the packets transmitted by the DUT, and displaying the marker packets, the test packets, and the packets transmitted by the DUT and thereby allowing a user to associate test packets and the packets transmitted by the DUT with the test steps identified by the marker packets.

According to another aspect of the subject matter described herein, the marker packets comprise fake packets configured to cause the DUT to ignore or discard the marker packets and, the test and marker packet generator is configured to transmit the fake packets to the DUT.

According to another aspect of the subject matter described herein, the fake packets each include a destination MAC address different from a MAC address of the DUT.

According to another aspect of the subject matter described herein, the fake packets comprise fake ICMP packets.

According to another aspect of the subject matter described herein, the packet capture application is configured to facilitate correlating of the specific test steps to the test packets captured by network test device using the specific test steps identified by the marker packets.

According to another aspect of the subject matter described herein, the marker packets include indicators that identify whether the specific test steps were successfully completed.

According to another aspect of the subject matter described herein, the test and marker packet generator is configured to transmit, to the DUT after completion of a first test step and prior to beginning a second test step, a first marker packet indicating completion of the first test step.

According to another aspect of the subject matter described herein, the marker packets each include an identifier that identifies the network conformance test.

According to another aspect of the subject matter described herein, the network test device is configured to feed the test packets, the marker packets, and the packets received from the DUT to a generative artificial intelligence/machine learning (AI/ML) model trained to interpret and facilitate navigation of results of the network conformance test.

According to another aspect of the subject matter described herein, a non-transitory computer readable medium having stored thereon executable instructions that when executed by a processor of a computer control the computer to perform steps comprising is provided. The steps include transmitting, by a network test device and to a device under test (DUT), a plurality of test packets as part of a network conformance test. The steps further include generating, by the network test device, a plurality of marker packets which identify specific test steps in the network conformance test, wherein the marker packets are configured so as not to change a state of the DUT with respect to the network conformance test. The steps further include transmitting, by the network test device, the marker packets. The steps further include receiving, by the network test device, packets transmitted by the DUT responsive to the test packets. The steps further include capturing, by the network test device, the test packets, the marker packets, and the packets transmitted by the DUT. The steps further include displaying the marker packets, the test packets, and the packets transmitted by the DUT and thereby allowing a user to associate test packets and the packets transmitted by the DUT with the test steps identified by the marker packets.

The subject matter described herein can be implemented in software in combination with hardware and/or firmware. For example, the subject matter described herein can be implemented in software executed by a processor. In one exemplary implementation, the subject matter described herein can be implemented using a non-transitory computer readable medium having stored thereon computer executable instructions that when executed by the processor of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

Exemplary implementations of the subject matter described herein will now be explained with reference to the accompanying drawings, of which:

FIG. 1 is a block diagram illustrating an exemplary test setup for performing a conformance test of a device under test;

FIG. 2 is a message flow diagram illustrating packets exchanged between a test device and a DUT in a network conformance test;

FIG. 3 is a message flow diagram illustrating a scenario in which a DUT passes a network conformance test, and marker packets or frames are used to frame or bracket the test packets to facilitate analysis of test results from a packet capture file;

FIG. 4 is a message flow diagram illustrating a scenario in which a DUT fails a network conformance test, and marker packets are used to frame or bracket test results;

FIG. 5 illustrates an example of a graphical user interface displayed by the packet capture utility executing on a test device;

FIG. 6 is a block diagram illustrating an exemplary architecture of a test device and the use of an AI/ML model to facilitate analysis of a packet capture file using marker packets; and

FIG. 7 is a flow chart illustrating an exemplary process for viewing and correlating test results in a network conformance test.

### DETAILED DESCRIPTION

Time sensitive networking (TSN) is a suite of standards, a successor of IEEE audio video bridging (AVB), that enables minimum latency over Ethernet, seamless redundancy, and centralized configuration and control. With TSN, companies can use standard Ethernet to implement a more cost-effective network that enables a converged IT/OT network that shares the same wire for critical time sensitive traffic and regular traffic.

Some network test products enable real-world validation of emerging technologies, substantiating the very edge of standards development. Equipment makers and companies use network test equipment to ensure devices and even whole networks meet the conformance criteria of TSN standards and the performance criteria of applications.

TSN conformance tests are crucial for validating that network devices comply with TSN standards, ensuring reliable, low-latency communication over Ethernet. These tests are defined by IEEE and ensure that devices support the deterministic, high-precision timing required for applications, such as industrial automation, automotive, and telecommunications. TSN conformance tests are used to verify that a product or system meets the TSN standards. TSN conformance tests can speed up product development and improve quality. By passing TSN conformance tests, network devices can be certified to operate reliably in time-sensitive environments, aligning with industry standards and ensuring compatibility with other TSN-compliant systems.

Some network test products allow users to automate TSN test suites. After completion of the test cases, the test products output test results into text file and generate packet capture files to verify the actual packet transmission timings, synchronization, and priorities. Users can analyze these packet captures to ensure that the packets align with expected TSN behavior and timing requirements. Network test users may find it challenging to analyze these captured packets, because it is difficult to correlate the test steps specified by IEEE and the packets used to implement the test steps.

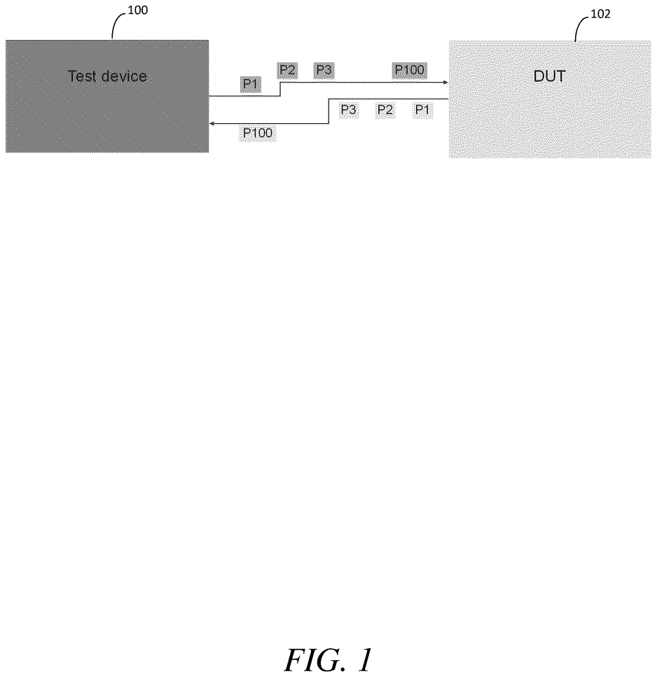

FIG. 1 is a block diagram illustrating an exemplary test setup for performing a conformance test of a device under test. In FIG. 1, a test device 100 generates and sends packets to a device under test (DUT) 102. Test device 100 also receives responsive packets from DUT 102. In one example test case, in step 1, test device 100 may send ten request messages to DUT 102. In test step 2, test device 100 may receive ten response messages from DUT 102. In test step 3, test device 100 may wait for a predetermined time. Before receiving data and verifying a signature from the device under test. Examples of tests that may be performed using the generic test setup in FIG. 1 include test defined standards bodies, such as the Institute of Electrical and Electronics Engineers (IEEE), International Telecommunications Union-Telephony (ITU-T), Avnu Alliance, Open Alliance, Open Network Foundation (ONF), etc.

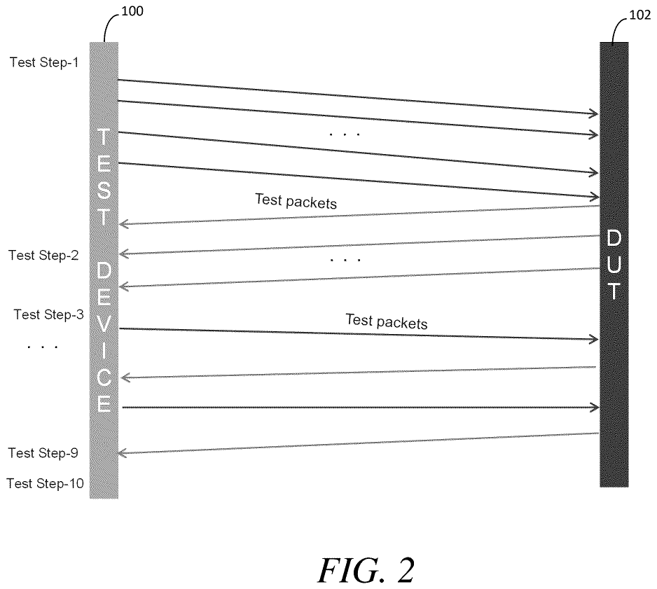

FIG. 2 is a message flow diagram illustrating packets exchanged between test device 100 and DUT 102 in a network conformance test. In the message flow in FIG. 2, in test step 1, test device 100 sends request messages to DUT 102. In step 2, test device 100 receives response messages from DUT 102. In steps 3-9, test device 100 and the DUT 102 exchange further messages and responses. In step 10, test device 100 receives data from DUT 102 and verifies a signature in the data.

One problem with the scenario illustrated in FIGS. 1 and 2 is that it is cumbersome for the end user to correlate exact packet exchanges with test steps. The user may need to correlate application logs with packet captures. If the test fails, it is difficult to determine the cause of the failure using manual correlation through packet logs.

To address these and other difficulties, the subject matter described herein includes generating and transmitting maker packets, which are fake or dummy packets, and which are structured not to modify the existing state of the DUT. In one example, the marker packets are Internet control management protocol (ICMP) echo request packets. These packets will be sent before and after test packets. The proposed solution will add a test step's description to payloads of the marker packets that are sent before the test packets. Marker packets may also be transmitted after test packets and may carry, in the marker packet payloads, text that indicates test step execution results (e.g., whether a test step or steps passed or failed).

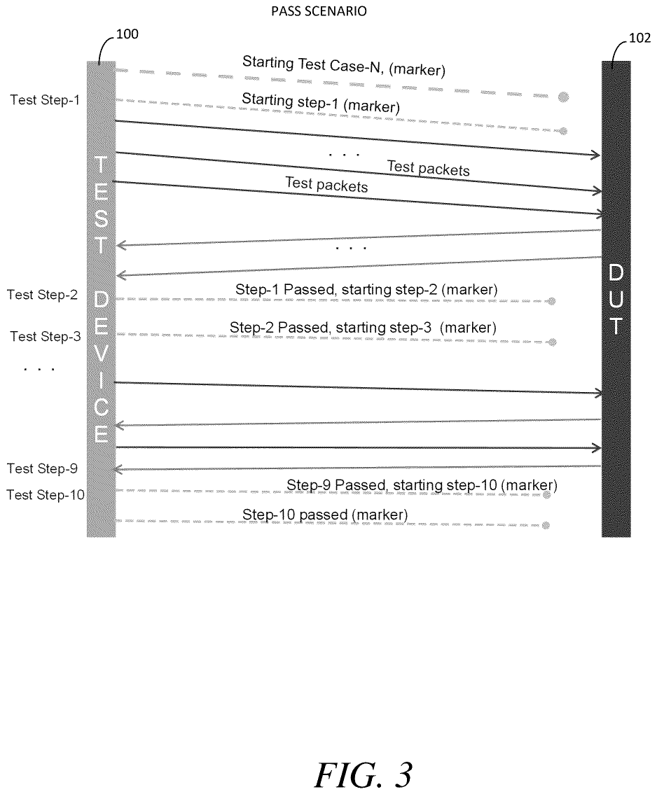

FIG. 3 is a message flow diagram illustrating a scenario where DUT 102 passes a network conformance test and marker packets or frames are used to associate the test packets with test steps to facilitate analysis of test results from a packet capture file. Referring to FIG. 3, prior to test step 1, test device 100 transmits two marker packets. The first marker packet indicates the name of the test case being started, and the second marker packet indicates that step 1 of the test is being started. After transmitting the two marker packets, test device 100 transmits test packets to DUT 102 and receives response packets from DUT 102. Test device 100 then determines that DUT 102 has passed test step 1 and sends a marker packet. The marker packet indicates that test step 1 was successfully completed and that test step 2 is starting. After test device 100 determines that DUT 102 has passed test step 2, test device 100 generates and transmits a marker packet indicating that test step 2 has passed and test step 3 is beginning. Test device 100 continues the process of executing test steps and transmitting a marker packet indicating that a test step has been successfully completed and that a new test step is beginning. It should be noted that the marker packets do not cause a change in state of DUT 102, and the marker packets are simply ignored or discarded.

The test packets and the marker packets are captured in a packet capture file captured by a packet capture utility running on test device 100. In one example, the packet capture utility is Wireshark, although using any packet capture application or utility is intended to be within the scope of the subject matter described herein. The marker packets allow the user to navigate test results in the packet capture file, as will be illustrated in further detail below.

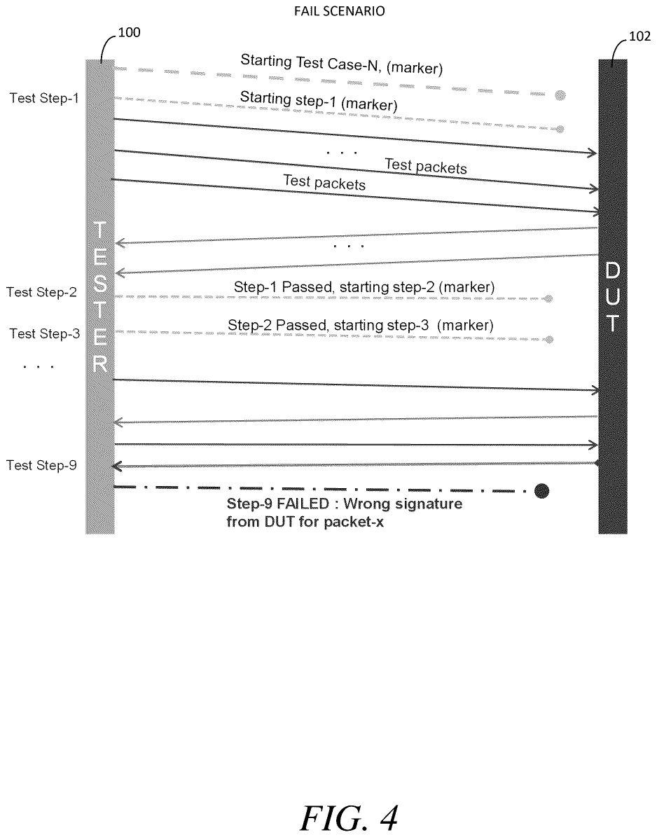

FIG. 4 is a message flow diagram illustrating a scenario in which a DUT fails a network conformance test, and marker packets are used to identify test steps and test step execution results. Referring to FIG. 4, prior to test step 1, test device 100 transmits two marker packets. The first marker packet indicates the name of the test case being started, and the second marker packet indicates that step 1 of the test is being started. After transmitting the two marker packets, test device 100 transmits test packets to DUT 102 and receives response packets from DUT 102. Test device 100 then determines that DUT 102 has passed test step 1 and sends a marker packet. The marker packet indicates that test step 1 was successfully completed and that test step 2 is starting. After test device 100 determines that DUT 102 has passed test step 2, test device 100 generates and transmits a marker packet indicating that test step 2 has passed and test step 3 is beginning. Test device 100 continues the process of executing test steps and transmitting a marker packet indicating that a test step has been successfully completed and that a new test step is beginning. In test step 9, test device 100 determines that DUT 102 inserted an incorrect signature in a response packet. Accordingly, after step 9, test device 100 generates and sends a marker packet indicating that test step 9 failed because an incorrect signature was generated by DUT 102 for packet x.

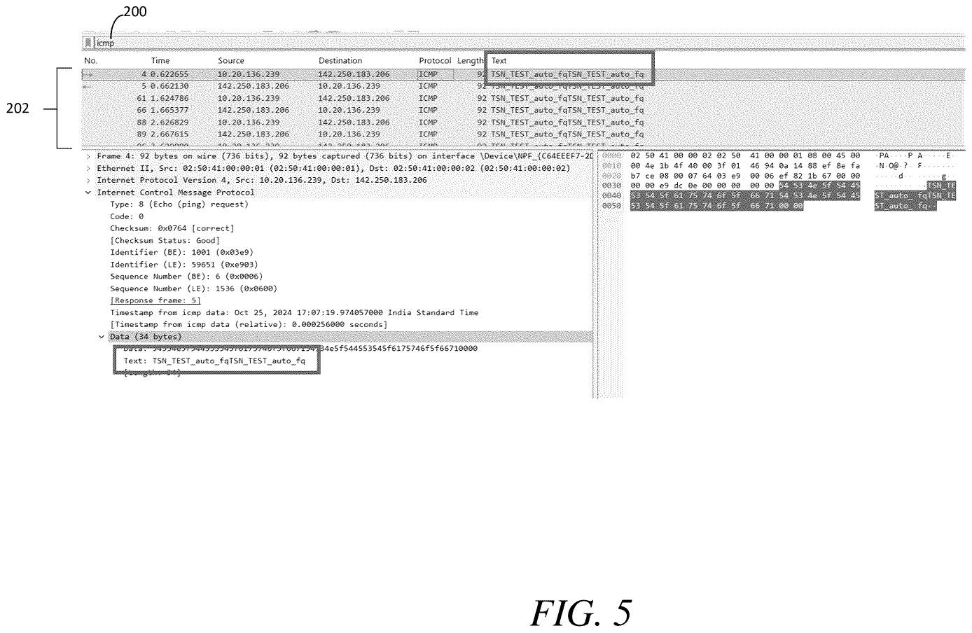

FIG. 5 illustrates an example of a graphical user interface displayed by the packet capture utility executing on test device 100. In FIG. 5, the graphical user interface includes a filter 200 that filters on packet parameters specified by the user. In the illustrated the example, the filter is set to “ICMP” so that the user interface will display only ICMP packets. Packets 202 are marker packets that delineate test results. In the illustrated example, the marker packets are shown for packet numbers 4, 5, 61, 66, 88, and 89, which may be used to bracket test results. Each marker packet carries text that specifies a test and a test step. Marker packets may have the following parameters:
1. Dest MAC, Src MAC
2. Eth-Type
3. IP Src and Dest, TTL (ideally will be set to 1)
4. ICMP Data, Sequence
5. Checksum engineering if required.
   In one example, the destination MAC address of a marker packet may be set to a fake or dummy MAC address that is not associated with DUT 102 so that DUT 102 will not process the marker packets.

The following is an example of data that may be included in marker packets to facilitate interpretation of test results:
1. Test Number [String] Delimited by 00
2. Test Step ID [String] Delimited by 00
3. Step Start or End [String] (BEGIN/__END) 5 bytes
4. Status [String] (PASS/FAIL/NOTA) 4 bytes
5. FAIL String in Brief (Expected=<Expected Val>, Received=<Received Val>) Variable (Delimited by 00)
6. Data End Marker—“KNCEND”.

In the example above, each marker packet includes text that identifies a test number, a test step identifier, a start or end identifier, a status identifier, and a data end identifier.

Test device 100 generates ICMP marker packets that carry test identification and status information in the marker packet and transmits the packets through a network interface, where packet capture is initiated. When generating the marker packets, test device 100 may modify the destination MAC address in each of the marker packets to set the destination MAC address to a value that is not equal to a DUT MAC address. This will ensure that the marker packets do not alter the state of the DUT with respect to the test being executed. In one example, the destination MAC address used by the marker packets is a user-configurable parameter. The user can specify the fake MAC address, or test device 100 will generate a unique MAC address to use in the marker packets per test execution. With marker packets, the user can use the Wireshark application's coloring rule highlight the marker packets by searching for packets with the assigned fake MAC address.

### Analysis of Packet Capture File Using Artificial Intelligence/Machine Learning (AI/ML) Model

According to another aspect of the subject matter described herein, the packet capture data, including the captured marker packets, may be fed to one or more AI/ML models for analysis. For example, packet capture data, such as that illustrated in FIG. 5 may be fed into a generative AI model, such as Chat GTP-4, for advanced analysis and retrieval of contextual results via a user-friendly prompt or co-pilot. The AI/ML model may be trained to analyze accuracy, drift, measure bias, minimize bias and optimize results across multiple capture data sets and correlate the results of a test with the relevant industry standards test plan.

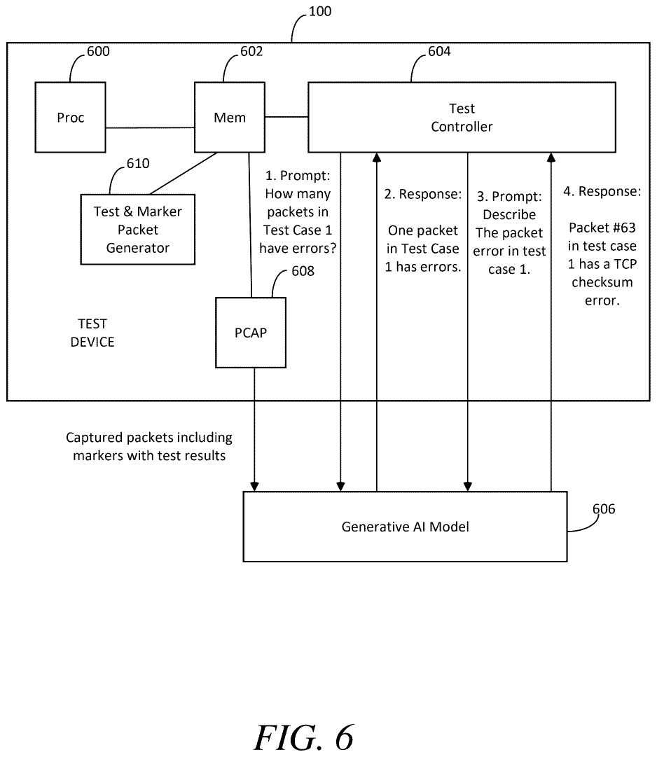

FIG. 6 is a block diagram illustrating an exemplary architecture of test device 100 and the use of an AI/ML model to facilitate analysis of a packet capture file using marker packets. FIG. 6, test device 100 includes at least one processor 600 and memory 602. Test device 100 further includes a test controller 604 for controlling the overall operation of test device 100 and for interacting with an AI/ML model, which in the illustrated example, is a generative AI model 606. Test device 100 further includes a packet capture (PCAP) application 608 that captures packets transmitted by and received by test device 100. In one example, PCAP application 608 may be a Wireshark application. Test device 100 further includes a test and marker packet generator 610 for generating test packets to transmit to DUT 102 and for generating marker packets to facilitate interpretation of test results. Test controller 604, PCAP application 608, and test and marker packet generator 610 may be implemented using computer executable instructions stored in memory 602 and executed by processor 600.

PCAP application 608 may also provide a feed of captured packets, including test packets and marker packets, to generative AI model 606. It is believed that the inclusion of marker packets which identify test cases, test steps, and test results in the feed provided to generative AI model 606 may function as labels that facilitates training and accuracy of generative AI model 606 in generating useful responses to prompts from a test device operator.

FIG. 6 also illustrates example prompts that may be provided by a test device operator to generative AI model 606 and corresponding responses that may be generated by generative AI model 606. In the illustrated example, the test system user issues a first prompt via test controller 604 that requests the number of packets in test case 1 that include errors. Generative AI model 606 trained on packet capture and marker packet data may respond with a response as indicated in step 2 that one packet in test case 1 has errors. The user may then issue another prompt that instructs generative AI model 606 to describe the error in test case 1. Generative AI model 606 may respond to the prompt using the PCAP data and the marker packets with a response that indicates that packet #63 in test case 1 has a TCP checksum error. Thus, using marker packets to label captured packet data may facilitate training a generative AI model and increase the accuracy of responses of the generative AI model.

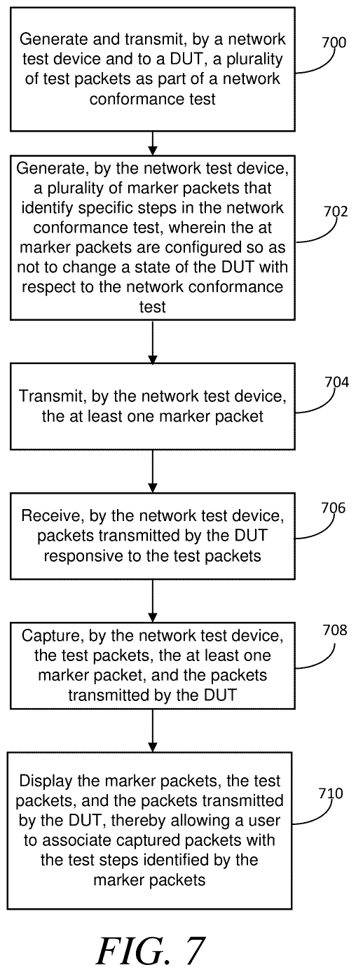

FIG. 7 is a flow chart illustrating an exemplary process for viewing and interpreting test results in a network conformance test. Referring to FIG. 7, in step 700, the process includes generating and transmitting, by a network test device and to a DUT, a plurality of test packets as part of a network conformance test. For example, a test device, such as test device 100 may generate test packets, such as TSN timing synchronization packets, as part of a TSN conformance test and transmit the test packets to the DUT.

In step 702, the process further includes generating, by the network test device, a plurality of marker packets that identify specific steps in the network conformance test, wherein the marker packets are configured so as not to change a state of the DUT with respect to the network conformance test. For example, the test device may configure the marker packets so that the test packets will be discarded or ignored by the DUT. In one example, the marker packets transmitted to the DUT may be configured with a destination MAC address that is different from a MAC address of the DUT. The marker packets may identify, in human-readable text format, the step or steps of the network test that precedes or follows each of the marker packets. For example, a marker packet sent after steps 1-3 of a TSN conformance test may indicated, “Steps 1-3 of TSN conformance test successfully completed, starting step 4.” Carrying test step identification and test step completion result information in marker packets enables a user to associate packets in a packet capture file with specific test steps.

In step 704, the process further includes transmitting, by the test device, the marker packets. For example, a test device, such as test device 100 may transmit marker packets to the DUT or to another node.

In step 706, the process further includes receiving, by the test device, packets transmitted by the DUT responsive to the test packets. For example, a test device, such as test device 100, may receive packets from the DUT that are responsive to the test packets transmitted to the DUT or that are forwarded by the DUT.

In step 708, the process further includes capturing, by the test device, the test packets, the marker packets, and the packets transmitted by the DUT. For example, a test device, such as test device 100 may capture test packets, marker packets, and response packets using a packet capture application, such as Wireshark.

In step 710, the process further includes displaying the marker packets, the test packets, and the packets transmitted by the DUT and thereby allowing a user to associate captured packets with the test steps identified by the east marker packets. For example, a test device, such as test device 100, may display a packet capture interface, such as that illustrated in FIG. 5 in which the test user can view the captured packets and marker packets in specified format, such as text or hexadecimal format. The marker packets may each identify a test step or steps so that the captured packets received before or after the marker packets can be associated with the test steps identified by the marker packets.

### Benefits

The subject matter described herein allows the user to easily locate test case steps and results in a packet capture file. The time required to interpret and navigate the packet capture file is reduced over the time required to interpret and navigate a packet capture file that does not include marker packets. A test case user can highlight packets in the GUI displayed by the packet capture application using a unique field, such as an Ethernet address, which helps the user to identify marker packets among large numbers of captured packets.

The subject matter described herein is believed to be particularly useful for TSN conformance testing applications in which the test device transmits timing synchronization packets to the DUT and receives responsive timing synchronization packets from the DUT. Marker packets can be used to indicate the identity of the TSN conformance test being performed, completion of specific test steps in the TSN conformance test, and whether or not the specified test steps are successfully completed.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for viewing and correlating test steps and captured packets in a network conformance test, the method comprising:
generating and transmitting, by a network test device and to a device under test (DUT), a plurality of test packets as part of a network conformance test;
generating, by the network test device, a plurality of marker packets that identify specific test steps in the network conformance test, wherein the marker packets are configured so as not to change a state of the DUT with respect to the network conformance test;
transmitting, by the network test device, the marker packets;
receiving, by the network test device, packets transmitted by the DUT responsive to the test packets;
capturing, by the network test device, the test packets, the marker packets, and the packets transmitted by the DUT; and
displaying the marker packets, the test packets, and the packets transmitted by the DUT and thereby allowing a user to associate test packets and the packets transmitted by the DUT with the test steps identified by the marker packets.

2. The method of claim 1 wherein generating the marker packets includes generating fake packets configured to cause the DUT to ignore or discard the at fake packets and wherein transmitting the marker packets includes transmitting the marker packets to the DUT.

3. The method of claim 2 wherein generating the fake packets includes generating packets addressed to a destination medium access control (MAC) address different from a MAC address of the DUT.

4. The method of claim 2 wherein generating the fake packets includes generating fake internet control management protocol (ICMP) packets.

5. The method of claim 1 comprising correlating the specific test steps to the test packets captured by network test device using the specific test steps identified by the marker packets.

6. The method of claim 1 wherein generating the marker packets includes inserting, in the marker packets, indicators that identify whether the specific test steps were successfully completed.

7. The method of claim 1 wherein transmitting the marker packets includes transmitting, after completion of a first test step and prior to beginning a second test step, a first marker packet indicating completion of the first test step.

8. The method of claim 1 wherein generating the marker packets includes inserting, in the marker packets, an identifier that identifies the network conformance test.

9. The method of claim 1 comprising feeding the test packets, the marker packets, and the packets received from the DUT to a generative artificial intelligence/machine learning (AI/ML) model trained to interpret and facilitate navigation of results of the network conformance test.

10. The method of claim 1 wherein the network conformance test comprises a time sensitive networking (TSN) conformance test.

11. A system for viewing and correlating test steps and captured packets in a network conformance test, the system comprising:
a network test device including at least one processor and a memory;
a test and marker packet generator implemented by the at least one processor for generating and transmitting, to a device under test (DUT), a plurality of test packets as part of a network conformance test, generating and transmitting a plurality of marker packets, wherein the marker packets identify specific test steps in the network conformance test and the marker packets are configured so as not to change a state of the DUT with respect to the network conformance test;
a packet capture application implemented by the at least one processor for receiving packets transmitted by the DUT responsive to the test packets, capturing, by the network test device, the test packets, the marker packets, and the packets transmitted by the DUT, and displaying the marker packets, the test packets, and the packets transmitted by the DUT and thereby allowing a user to associate the test packets and the packets transmitted by the DUT with the test steps identified by the marker packets.

12. The system of claim 11 wherein the marker packets comprise fake packets configured to cause the DUT to ignore or discard the marker packets and, the test and marker packet generator is configured to transmit the fake packets to the DUT.

13. The system of claim 12 wherein the fake packets each include a destination medium access control (MAC) address different from a MAC address of the DUT.

14. The system of claim 12 wherein the fake packets comprise fake internet control management protocol (ICMP) packets.

15. The system of claim 11 wherein the packet capture application is configured to facilitate correlating of the specific test steps to the test packets captured by network test device using the specific test steps identified by the marker packets.

16. The system of claim 11 wherein the marker packets include indicators that identify whether the specific test steps were successfully completed.

17. The system of claim 11 wherein the test and marker packet generator is configured to transmit, to the DUT after completion of a first test step and prior to beginning a second test step, a first marker packet indicating completion of the first test step.

18. The system of claim 11 wherein the marker packets each include an identifier that identifies the network conformance test.

19. The system of claim 11 wherein the network test device is configured to feed the test packets, the marker packets, and the packets received from the DUT to a generative artificial intelligence/machine learning (AI/ML) model trained to interpret and facilitate navigation of results of the network conformance test.

20. A non-transitory computer readable medium having stored thereon executable instructions that when executed by a processor of a computer control the computer to perform steps comprising:
transmitting, by a network test device and to a device under test (DUT), a plurality of test packets as part of a network conformance test;
generating, by the network test device, a plurality of marker packets which identify specific test steps in the network conformance test, wherein the marker packets are configured so as not to change a state of the DUT with respect to the network conformance test;
transmitting, by the network test device, the marker packets;
receiving, by the network test device, packets transmitted by the DUT responsive to the test packets;
capturing, by the network test device, the test packets, the marker packets, and the packets transmitted by the DUT; and
displaying the marker packets, the test packets, and the packets transmitted by the DUT and thereby allowing a user to associate test packets and the packets transmitted by the DUT with the test steps identified by the marker packets.
